(19) United States
(12) Patent Application Publication
(10) Pub. No.: US 2025/0340801 A1
(43) Pub. Date: Nov. 6, 2025

(54) COMPOSITION, HOME CARE FORMULATIONS, METHOD AND USE

(71) Applicant: CRODA INTERNATIONAL PLC, Goole East Yorkshire (GB)

(72) Inventors: Patrick James COLVER, Goole, East Yorkshire (GB); Christopher HEALD, Goole, East Yorkshire (GB); Suzanne Burn LEES, Goole, East Yorkshire (GB)

(73) Assignee: Croda International Plc, Goole, East Yorkshire (GB)

(21) Appl. No.: 18/870,936

(22) PCT Filed: Jun. 21, 2023
(86) PCT No.: PCT/EP2023/066793

§ 371 Date: Dec. 2, 2024

(30) Foreign Application Priority Data
Jun. 28, 2022 (GB) 2209432.0

(51) Int. Cl. C11D 3/20; C11D 3/00; C11D 3/33; C11D 3/37; C11D 3/39; C11D 3/50

(52) U.S. Cl. CPC C11D 3/2096; C11D 3/001; C11D 3/33; C11D 3/3769; C11D 3/3927; C11D 3/50; C11D 2111/12

(57) ABSTRACT

The present invention provides a composition comprising the reaction product of a) itaconic anhydride; and b) an amino compound comprising at least one free amino group, wherein the amino compound is selected from hydrolysed proteins; wherein the composition comprises itaconic modified amino compound, wherein the itaconic modified amino compound is the reaction product of a) and b). In another embodiment, the amino compound is selected from the group consisting of amino acids, peptides and hydrolysed proteins. The invention further provides a home care formulation comprising the composition of the invention, a fabric conditioner or softener, a method of treating fibres and a use of the composition.

### FIELD OF INVENTION

The present invention relates to a composition, home care formulations comprising the composition such as fabric conditioners or softeners, a method of treating fibres with the composition and use of the composition to provide a benefit to fibres.

### BACKGROUND

Fabric conditioners or softeners have been used for many years as home care formulations, specifically for improving the properties of fabrics such as washed laundry.

A non-limiting example of a fabric conditioner is given in EP2029712 which discloses aqueous rinse-cycle concentrated fabric softener formulations, which are capable of being diluted with water prior to use, to provide a physically stable softener composition in both the concentrated and diluted forms.

There exists a desire to remove fossil-fuel-based ingredients from such products to improve their environmental profile.

It is an object of the present invention to address at least one of the disadvantages associated with the prior art.

### SUMMARY OF THE INVENTION

The present invention is based in part on the surprising recognition that the reaction product of itaconic anhydride and amino acid containing compounds, particularly hydrolysed proteins, can produce a composition which is beneficial in the treatment of fibres such as fabric fibres in a process such as a laundry process. The fibres may form part or all of a woven or non-woven fabric or garment. In particular, the composition of the invention may be used as a fabric or fibre benefit agent in a home care formulation such as a fabric conditioner or softener. The composition of the invention may be used in a method of treating fibres and or fabrics such as a laundry method or process. The benefit provided by the composition of the invention may be selected from fabric conditioning, easy ironing, colour protection, print protection, odour neutralisation, perfume boosting, fabric strength retention and shape retention.

Thus viewed from a first aspect, the present invention provides a composition comprising the reaction product of:
a) itaconic anhydride; and
b) an amino compound comprising at least one free amino group, wherein the compound is selected from the group consisting of amino acids, peptides and hydrolysed proteins;
wherein the composition comprises itaconic modified amino compound, wherein the itaconic modified amino compound is the reaction product of a) and b), and wherein the amount of itaconic anhydride used in the reaction is calculated to react with 1 mol % to 100 mol % of the free amino groups of the amino compound, preferably calculated by the Formol titre as described herein.

Viewed from a second aspect, the present invention provides a composition comprising the reaction product of:
a) itaconic anhydride; and
b) an amino compound comprising at least one free amino group, wherein the amino compound is selected from hydrolysed proteins;
wherein the composition comprises itaconic modified amino compound, wherein the itaconic modified amino compound is the reaction product of a) and b).

The composition of the invention may be advantageous by not comprising any reactants obtained from a petrochemical source. The itaconic anhydride may be obtained from a renewable source. The itaconic anhydride may be obtained from citric acid. The itaconic anhydride may be obtained from a biological source, preferably from a microbiological source. The amino compound may be obtainable from a renewable source, preferably from a renewable protein source.

Viewed from a third aspect, the present invention provides a home care formulation comprising a composition of the first or second aspect. Preferably the home care formulation is a fabric conditioner or softener.

Viewed from a fourth aspect, the present invention provides a method of treating fibres, preferably treating fabric fibres, particularly a method of fabric conditioning comprising the step of applying a composition according to the first or second aspect to the fibres and/or fabric. The method may be part of a laundry method or process.

Viewed from a fifth aspect, the present invention provides the use of a composition according to the first or second aspect of the invention to treat fibres and/or fabric to provide a benefit to the fibres and/or fabric. The benefit may be selected from fabric conditioning, easy ironing, colour protection, print protection, odour neutralisation, perfume boosting, fabric strength retention and shape retention. The use may be part of a laundry method or process.

All of the features described herein may be combined with any of the above aspects, in any combination.

### DETAILED DESCRIPTION OF THE INVENTION

It will be understood that any upper or lower quantity or range limit used herein may be independently combined.

Many of the chemicals which may be used to produce the composition of the present invention are obtained from natural sources. Such chemicals typically include a mixture of chemical species due to their natural origin. Due to the presence of such mixtures, various parameters defined herein can be an average value and may be non-integral.

It will be understood that, when describing the number of carbon atoms in a substituent group (e.g. ‘C1 to C6’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branch groups.

The term ‘residue’ as used herein is the part of a reactant molecule which remains in the reaction product compound after a reaction has occurred.

The term ‘hydrolysed protein’ is used herein to mean proteins which have been subject to hydrolysis. The hydrolysed protein may comprise protein fragments, polypeptides, peptides, amino acids and/or peptones. The hydrolysed protein may be produced by acid hydrolysis, alkali hydrolysis, and/or enzyme hydrolysis of proteins, preferably naturally occurring proteins or proteins from renewable sources. Enzyme hydrolysis is preferred. Without being bound by theory, an advantage of enzyme hydrolysis when compared with acid or alkali hydrolysis is that the enzyme hydrolysis is more selective in the sites on the protein which are hydrolysed, thus producing an improved amino compound for use in making the composition of the invention when compared with acid or alkali hydrolysis. In general, acid hydrolysis may produce the smallest fragments by weight average molecular weight, alkali hydrolysis may produce the largest fragments, while enzyme hydrolysis may produce fragments of intermediate size between acid and alkali hydrolysis. The size of a fragment in the hydrolysed protein is proportional to the number of amino acid residues in the fragment since the fragments come from the long amino acid chains which make up the unhydrolysed protein. Acid hydrolysis may be disadvantageous due to high temperature and/or pressure requirements. Alkali hydrolysis may be disadvantageous due to the need to use irritant or hazardous chemicals.

The amino compound used in making the composition of the invention may be a chemically unmodified hydrolysed protein. The term ‘chemically unmodified hydrolysed protein’ means a protein that has not been further chemically modified (or reacted) other than by hydrolysis.

The amino compound used in making the composition of the invention may be a partially hydrolysed protein. The term ‘partially hydrolysed protein’ means a protein that has not been hydrolysed completely i.e. not been hydrolysed to the extent that only individual amino acids remain in the amino compound.

The term ‘home care formulation’ when used herein means a consumer product for use by household and/or institutional consumers for cleaning, caring, or conditioning of the home or its contents such as fabrics. Home care formulations include but are not limited to detergents including laundry detergents and dishwashing detergents; conditioners including fabric conditioners; cleaning formulations including hard surface cleaners; polishes and floor finishes.

### Composition of the Invention

The composition of the invention comprises the reaction product of:
a) itaconic anhydride; and
b) an amino compound comprising at least one free amino group, wherein the amino compound is selected from hydrolysed proteins;
wherein the composition comprises itaconic modified amino compound, wherein the itaconic modified amino compound is the reaction product of a) and b).

Viewed from another aspect, the composition of the invention comprises the reaction product of:
a) itaconic anhydride; and
b) an amino compound comprising at least one free amino group, wherein the compound is selected from the group consisting of amino acids, peptides and hydrolysed proteins;
wherein the composition comprises itaconic modified amino compound, wherein the itaconic modified amino compound is the reaction product of a) and b), and wherein the amount of itaconic anhydride used in the reaction is calculated to react with 1 mol % to 100 mol % of the free amino groups of the amino compound. Preferably the amount of itaconic anhydride required is calculated by the Formol titre as described herein.

Preferably the composition further comprises water. The composition may comprise at least 10 wt % water, preferably at least 20 wt % water, more preferably at least 30 wt % water, particularly at least 40 wt % water, desirably at least 50 wt % water, especially at least 60 wt % water, on the basis of the total weight of the composition. The composition may comprise at most 90 wt % water, preferably at most 80 wt % water on the basis of the total weight of the composition.

The composition may further comprise itaconic acid. The itaconic acid may be formed by a minor side-reaction of the itaconic anhydride with water. This side reaction may reduce the amount of itaconic anhydride which actually reacts with the free amino groups of the amino compound by a minor amount, when compared with the theoretical amount calculated by the Formol titre as described herein. Therefore it may be preferable to minimise the side-reaction of itaconic anhydride with water by selecting suitable reaction conditions. Preferably the amount of itaconic anhydride added to react with the amino compound is the theoretical amount calculated to react with a specified mol % of the amino groups in the amino compound. Preferably the theoretical amount is calculated by the Formol titre.

The itaconic anhydride may be obtained from a renewable source. Preferably the itaconic anhydride is not obtained from a petrochemical source. The itaconic anhydride may be obtained from citric acid. The itaconic anhydride may be obtained from a biological source, preferably from a microbiological source. Preferably the itaconic anhydride is substantially pure itaconic anhydride, for example at least 85 wt % itaconic anhydride, preferably at least 90 wt % itaconic anhydride, more preferably at least 95 wt % itaconic anhydride.

Preferably the amino compound is obtained from a renewable source. Preferably the amino compound is not obtained from an animal protein source. This is advantageous since animal sources can be undesirable for consumers. Preferably the composition comprises no animal-derived components. Preferably the composition comprises no petrochemical-derived components. Preferably the carbon-containing parts of the composition are at least 80% biobased according to ASTM D6866 on the basis of the total weight of the carbon-containing parts of the composition, more preferably at least 90%, particularly at least 95%, desirably at least 99%, especially 100% biobased. Preferably the composition is suitable for vegan consumers.

Preferably the amino compound comprises hydrolysed protein, more preferably consists essentially of hydrolysed protein, more preferably is hydrolysed protein. The hydrolysed protein may be produced by acid, alkali or enzyme hydrolysis. Enzyme hydrolysis is preferred. One or more enzymes may be used. The enzyme is preferably not animal derived. Preferably the enzyme is from a micro-organism source. The enzyme(s) may comprise a carbohydrase and/or a protease. Preferably the enzyme comprises a protease. The hydrolysis may be performed to the extent required to achieve the desired weight average molecular weight of the hydrolysed protein. The extent of hydrolysis may be varied by varying the temperature, acid/alkali/enzyme used, and time taken. The resulting hydrolysed protein may be filtered and/or treated to remove undesired material. For example the hydrolysed protein may be treated to remove any chloride ions present if acid hydrolysis is used.

The hydrolysed protein may be obtained from a natural source. The hydrolysed protein may be obtained from a renewable source. Preferably the hydrolysed protein is a hydrolysed vegetable protein. The vegetable protein may be selected from potato, wheat, cottonseed, pea, chickpea and soya, preferably selected from potato, wheat, pea and chickpea more preferably selected from potato and chickpea. Preferably the amino compound is a hydrolysed potato or chickpea protein. The composition may not comprise hydrolysed wheat protein or protein obtained from a wheat source. This may be advantageous since wheat protein may be undesirable for certain consumers.

Preferably the amino compound comprises oligomers of amino acids, which may also be known as oligopeptides. These oligomers may be hydrolysed protein fragments. The amino compound may comprise oligomers of 2 to 20 amino acids (also known as residues) in average size, preferably of 2 to 15 amino acids, more preferably of 2 to 10 amino acids. Preferably the average size is a weight average size. The amino acids in the oligomers may be the same or different amino acids. The amino acids in the oligomers preferably comprise at least one glutamic acid residue or histidine residue, more preferably comprise at least one glutamic acid residue. The amino compound may not be an individual amino acid. Preferably the amino compound does not consist of individual amino acids. Alternatively, the amino compound may comprise glutamic acid or histidine as individual amino acids, preferably glutamic acid.

The weight average molecular weight (Mw) of the amino compound may be at least 200 Daltons (Da), preferably at least 300 Da, more preferably at least 400 Da. The weight average molecular weight of the amino compound may be at most 50,000 Da, preferably at most 20,000 Da, more preferably at most 10,000 Da, yet more preferably at most 5,000 Da. The weight average molecular weight of the amino compound may be at most 2,500 Da, preferably at most 2,000 Da, more preferably at most 1,500 Da. The molecular weight may be measured by size exclusion chromatography, preferably measured by size-exclusion HPLC (SE-HPLC) as described in the Test Methods below. Preferably the amino compound has a weight average molecular weight in the range from 200 Da to 5000 Da, preferably 200 Da to 3000 Da, preferably 200 to 1500 Da.

Preferably, the composition of the invention is substantially free from quaternary ammonium compounds. By the use of the term “substantially free from”, it is meant that the composition comprises preferably less than 10% by weight, more preferably less than 5% by weight, yet more preferably less than 2% by weight and most preferably, less than 1% by weight based on the total weight of the composition. Preferably, the composition does not comprise a quaternary ammonium compound.

Preferably, the composition of the invention is substantially free from silicone compounds. By the use of the term “substantially free from”, it is meant that the composition comprises preferably less than 10% by weight, more preferably less than 5% by weight, yet more preferably less than 2% by weight and most preferably, less than 1% by weight based on the total weight of the composition. Preferably, the composition comprises no silicone compounds. Preferably the composition does not comprise an organosilane, organosilicon or silicone compound.

The composition may further comprise one or more preservatives. The composition may comprise at least 0.1 wt % preservative, preferably at least 0.2 wt %, more preferably at least 0.4 wt %, particularly at least 0.6 wt % on the basis of the total weight of the composition. The composition may comprise at most 10 wt % preservative, preferably at most 5 wt %, more preferably at most 3 wt %, particularly at most 2 wt % on the basis of the total weight of the composition. The preservative may comprise phenoxyethanol, a benzoate or a sorbate, more preferably the preservative is selected from benzoates and sorbates, more preferably the preservative comprises sodium benzoate and/or potassium sorbate. Alternatively, the composition may not comprise a preservative.

The composition may be a liquid at room temperature (25° C.). The composition may be a solution or dispersion, preferably a solution, of the itaconic modified amino compound in a solvent, preferably the solvent comprises water.

Alternatively the composition may not comprise water or may comprise residual water after drying to a solid or powder form. Spray drying may be used to dry the composition. The composition may be a solid or powder.

### Ratios of Reactants

The reactants for the composition of the invention comprise:
a) itaconic anhydride; and
b) an amino compound comprising at least one free amino group, wherein the compound is selected from the group consisting of amino acids, peptides and hydrolysed proteins.

The composition comprises itaconic modified amino compound, wherein the itaconic modified amino compound is the reaction product of a) and b), and wherein the amount of itaconic anhydride used is calculated to react with 1 mol % to 100 mol % of the free amino groups of the amino compound.

The ratio of reactants may surprisingly influence the properties of the composition of the invention. Preferably at least 2 mol %, more preferably at least 5 mol %, more preferably at least 10 mol %, more preferably at least 15 mol %, more preferably at least 20 mol % of the free amino groups in the amino compound are reacted with the itaconic anhydride in the itaconic modified amino compound. Preferably at most 99 mol %, more preferably at most 98 mol %, more preferably at most 95 mol %, more preferably at most 90 mol % more preferably at most 80 mol %, more preferably at most 70 mol %, more preferably at most 60 mol %, more preferably at most 50 mol %, more preferably at most 40% of the free amino groups in the amino compound are reacted with the itaconic anhydride in the itaconic modified amino compound. Preferably the amount of itaconic anhydride used is calculated to react with 5 mol % to 70 mol % of the free amino groups in the amino compound. More preferably the amount of itaconic anhydride used is calculated to react with 20 mol % to 50 mol % of the free amino groups in the amino compound. Preferably the calculation is by Formol titre as described herein.

### Home Care Formulations

Preferably the composition of the invention is suitable for use in home care formulations. Viewed from a second aspect, the present invention provides a home care formulation comprising the composition of the invention. The home care formulation may be selected from fabric detergents (in liquid, powder, concentrated, unit dose or tablet form), fabric conditioners or softeners (in liquid, powder, concentrated, unit dose or tablet form), fabric wash additives (e.g. solid or liquid laundry ancillaries), fabric scent boosters (in liquid, gel, tablet, powder or granule form), refresher sprays, fabric sprays, solid detergent bars, air care products, cleaning products, fabric cleaners, stain removers, hard surface cleaners, hand dishwashing detergents, machine dishwashing detergents, polishes and floor finishes. Preferably the home care formulation is selected from fabric conditioners or softeners, fabric detergents, fabric wash additives, fabric scent boosters, refresher sprays, air care products and cleaning products. Preferably the home care formulation is a fabric conditioner or softener.

The home care formulation, preferably fabric conditioner or softener, may comprise the composition according to the invention and at least one additional home care ingredient. The home care ingredient may be selected from detergents, surfactants, ironing aides, drying additives, builders, chelating agents, dye transfer inhibiting agents, dispersants, enzymes, enzyme stabilizers, catalytic materials, bleaches, bleach activators, hydrogen peroxide, sources of hydrogen peroxide, preformed peracids, polymeric dispersing agents, soil removal/anti-redeposition agents, brighteners, suds suppressors, dyes, fabric softening compounds, carriers, structurants, hydrotropes, processing aids, solvents and/or pigments and mixtures thereof. Preferably the home care ingredient is selected from the group consisting of surfactants, builders, chelating agents and fabric softening compounds. The home care formulation may comprise the composition according to the invention and at least one surfactant. The at least one surfactant may be selected from anionic, cationic, non-ionic and zwitterionic surfactants, preferably anionic and cationic surfactants.

The home care formulation may comprise from 0.01 to 10 wt % of the itaconic modified amino compound, on the basis of the total weight of the formulation. Preferably the home care formulation comprises at least 0.02 wt %, more preferably at least 0.05 wt %, more preferably at least 0.1 wt %, more preferably at least 0.2 wt % of the itaconic modified amino compound, on the basis of the total weight of the formulation. Preferably the home care formulation comprises at most 20 wt %, more preferably at most 15 wt %, more preferably at most 10 wt %, more preferably at most 5 wt % of the itaconic modified amino compound, on the basis of the total weight of the formulation.

### Fabric Conditioner or Fabric Softener Formulations

Preferably the home care formulation comprising the composition of the present invention is a fabric conditioner or fabric softener. Fabric conditioners or softeners comprise active materials or agents which condition or soften fabric. These compounds may be known as fabric softening compounds and may be any material known to soften fabrics. Preferably the fabric conditioner or softener further comprises a fabric softening compound

The fabric conditioner or softener may comprise from 0.01 to 10 wt % of the itaconic modified amino compound, on the basis of the total weight of the formulation. Preferably the fabric conditioner or softener comprises at least 0.02 wt %, more preferably at least 0.05 wt %, more preferably at least 0.1 wt %, more preferably at least 0.2 wt % of the itaconic modified amino compound, on the basis of the total weight of the formulation. Preferably the fabric conditioner or softener comprises at most 20 wt %, more preferably at most 15 wt %, more preferably at most 10 wt %, more preferably at most 5 wt % of the itaconic modified amino compound, on the basis of the total weight of the formulation.

Preferably the fabric conditioner or softener formulation comprises the composition according to the invention and a fabric softening compound. Preferably the fabric softening compound is selected from quaternary ammonium compounds, polysaccharides, clays, amines, fatty esters, dispersible polyolefins, polymer latexes and mixtures thereof, more preferably selected from quaternary ammonium compounds, polysaccharides, amines and fatty esters. Preferably the fabric conditioner or softener formulation comprises a quaternary ammonium compound.

Alternatively, the fabric conditioner or softener formulation may be substantially free from quaternary ammonium compounds. By the use of the term “substantially free from”, it is meant that the formulation comprises preferably less than 10% by weight, more preferably less than 5% by weight, yet more preferably less than 2% by weight and most preferably, less than 1% by weight based on the total weight of the formulation of quaternary ammonium compounds. The fabric conditioner or softener formulation may not comprise a quaternary ammonium compound.

The fabric softening compounds may preferably be cationic or non-ionic. Preferably, the fabric softening compounds of the present invention are cationic. Suitable cationic fabric softening compounds are described below. Fabric conditioner or softener formulations for use in accordance with the invention may be dilute or concentrated.

Dilute formulations typically contain up to about 6%, generally about 1 to 5% by weight of fabric softening compounds, whereas concentrated formulations may contain up to about 50%, preferably from about 5 to about 50%, more preferably from 6 to 25% by weight of fabric softening compounds on the basis of the total weight of the formulation. Overall, the fabric conditioner or softener may contain from 1 to 50 wt %, preferably from 2 to 25 wt % of softening compounds, more preferably 2 to 20 wt % of softening compounds on the basis of the total weight of the formulation.

### Cationic Fabric Softening Compound

A cationic fabric softening compound for use in a fabric conditioner or fabric softener formulation of the invention is typically a quaternary ammonium compound (“QAC”). Preferred QACs have two C₁₂₋₂₈ groups connected to the nitrogen head group that may independently be alkyl or alkenyl groups, preferably being connected to the nitrogen head group by at least one ester link, and more preferably by two ester links. The average chain length of the alkyl and/or alkenyl groups is preferably at least C₁₄ and more preferably at least C₁₆. It is particularly preferred that at least half of the groups have a chain length of C₁₈. In general, the alkyl and/or alkenyl groups are predominantly linear.

A first group of QACs suitable for use in the present invention is represented by formula (I):

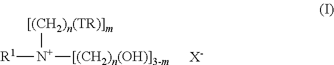

wherein each R is independently selected from a C₅₋₃₅ alkyl or alkenyl group; R¹ represents a C₁₋₄ alkyl, C₂₋₄ alkenyl or a C₁₋₄ hydroxyalkyl group; T is generally O—CO. (i.e. an ester group bound to R via its carbon atom), but may alternatively be CO·O (i.e. an ester group bound to R via its oxygen atom); n is a number selected from 1 to 4; m is a number selected from 1, 2, or 3; and X⁻ is an anionic counter-ion, such as a halide or alkyl sulphate, e.g. chloride or methylsulphate. Di-esters variants of formula I (i.e. m=2) are preferred and typically have mono- and tri-ester analogues associated with them. Such materials are particularly suitable for use in the present invention.

Especially preferred agents are di-esters of triethanolammonium methylsulphate, otherwise referred to as “TEA ester quats.”. Commercial examples include Prapagen TQL, ex Clariant, and Tetranyl AHT-1, ex Kao, (both di-[hardened tallow ester] of triethanolammonium methylsulphate), AT-1 (di-[tallow ester] of triethanolammonium methylsulphate), and L5/90 (di-[palm ester] of triethanolammonium methylsulphate), both ex Kao, and Rewoquat WE15 (a di-ester of triethanolammonium methylsulphate having fatty acyl residues deriving from C₁₀-C₂₀ and C₁₆-C₁₈ unsaturated fatty acids), ex Witco Corporation.

The second group of QACs suitable for use in the invention is represented by formula (II):

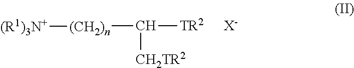

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; and wherein n, T, and X⁻ are as defined above. Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180. Preferably, these materials also comprise an amount of the corresponding mono-ester.

A third group of QACs suitable for use in the invention is represented by formula (III):

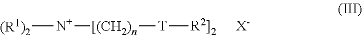

wherein each R¹ group is independently selected from C₁₋₄ alkyl, or C₂₋₄ alkenyl groups; and wherein each R² group is independently selected from C₈₋₂₈ alkyl or alkenyl groups; and n, T, and X⁻ are as defined above. Preferred materials of this third group include bis(2-tallowoyloxyethyl)dimethyl ammonium chloride and hardened versions thereof.

A fourth group of QACs suitable for use in the invention is represented by formula (IV):

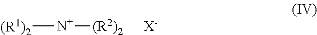

wherein each R¹ group is independently selected from C₁₋₄ alkyl, or C₂₋₄ alkenyl groups; and wherein each R² group is independently selected from C₈₋₂₈ alkyl or alkenyl groups; and X⁻ is as defined above. Preferred materials of this fourth group include di(hardened tallow)dimethylammonium chloride.

The cationic softening compound is usually present in the fabric conditioner or softener formulation at a level of 2% to 75% by weight of the total formulation. For even greater softening effect, this level may be 8% or greater; whilst for particularly high performance, this level may be 11% or greater. The level of cationic softening compound is most preferably 10 to 30% by weight, e.g. 12.5 to 28% by weight of the total formulation.

References to levels of cationic softening compound in this specification are to the total level of cationic softening compound, including all cationic components of a complex raw material that could enter the aqueous lamellar phase together. With a di-ester softening agent, it includes any associated mono-ester or tri-ester components that may be present.

### Cationic Cross-Linked Polymer

The fabric conditioner or softener formulation may comprise a cationic cross-linked polymer. The cationic cross-linked polymer may be derivable from the polymerization of from 5 to 100 mole percent of cationic vinyl addition monomer, from 0 to 95 mole percent of acrylamide and from 50 to 1000 ppm of a difunctional vinyl addition monomer cross-linking agent. Preferred polymers are cross-linked copolymers of acrylamide and methacrylate cross-linked with a difunctional vinyl addition monomer, such as methylene bisacrylamide. Particularly preferred polymers are copolymers of from about 20% acrylamide and about 80% MADAM methyl chloride (MADAM is dimethyl amino ethyl methacrylate) cross-linked with from 450 to 600 ppm of methylene bisacrylamide. Such materials are commercially available from SNF Floerger under the trade names Flosoft 200 and Flosoft 222.

### Supplementary Cationic Polymers

The fabric conditioner or softener formulation may additionally comprise additional cationic polymers to assist with viscosity control. Such polymers are generally used in amounts less than the cationic cross-linked polymer described above e.g. in a weight ratio of 1:2 to 1:5 supplementary polymer:cationic cross-linked polymer. Suitable supplementary polymers include non-acrylamide based polymers such as, Rheovis CDE commercially available from Ciba Speciality Chemicals.

### Electrolyte

There may be trace amounts of electrolyte e.g. NaCl, present in the raw materials used to form the fabric conditioner or softener formulation. However, additional electrolyte may be added. The added electrolyte may be present in an amount effective to provide a viscosity in the range from 300 to 1000 mPa·s at 25° C. The precise concentration depends upon the electrolyte of choice and is generally in the range from 0.001 to 0.2% by weight, preferably 0.001 to 0.1%, more preferably 0.001 to 0.05% by weight of the formulation. A preferred electrolyte is CaCl₂ although other electrolytes, such as MgCl₂, NaCl etc may be used.

### Fatty Co-Actives

A preferred additional component in the fabric conditioner or softener formulation is a fatty co-active. Such agents typically have a C₈ to C₂₂ hydrocarbyl chain present as part of their molecular structure. Suitable fatty co-actives include C₈ to C₂₂ fatty alcohols and C₃ to C₂₂ fatty acids; of these, the C₃ to C₂₂ fatty alcohols are most preferred. A fatty co-active is particularly valuable in compositions comprising a QAC having a single C₁₂₋₂₈ group connected to the nitrogen head group, such as mono-ester associated with a TEA ester quat. or a softening agent of formula II, for reasons of product stability and effectiveness. Preferred fatty acid co-actives include hardened tallow fatty acid (available as Pristerene, range ex Uniqema).

Preferred fatty alcohol co-actives include hardened tallow alcohol (available as Stenol and Hydrenol, ex Cognis, and Laurex CS, ex Albright and Wilson) and behenyl alcohol, a C₂₂ fatty alcohol, available as Lanette 22, ex Henkel. These co-actives may be used at from 0.1% to 10%, particularly at from 0.5% to 5%, and especially at from 0.75 to 2% by weight, based on the total weight of the formulation.

Other co-actives, such as fatty esters, and fatty N-oxides may be used together with the cationic softening compound. When employed, they are typically present at from 0.1 to 20% and particularly at from 0.5 to 10%, based on the total weight of the formulation.

Fatty esters that may be employed include fatty monoesters, such as glycerol monostearate, fatty sugar esters, such as those disclosed in WO01/46361.

### Perfume

Preferably the fabric conditioner or softener further comprises a perfume. The perfume is preferably present in an amount from 0.01 to 10% by weight, more preferably 0.05 to 5% by weight, most preferably 0.5 to 4.0% by weight, based on the total weight of the formulation.

### Further Optional Ingredients

The fabric conditioner or softener formulation of the invention may contain one or more other ingredients. Such ingredients include preservatives (e.g. bactericides), pH buffering agents, perfume carriers, opacifiers, pearlescers, fluorescers, colourants, hydrotropes, antifoaming agents, anti-redeposition agents, soil-release agents, polyelectrolytes, enzymes, optical brightening agents, anti-shrinking agents, anti-wrinkle agents, anti-spotting agents, anti-oxidants, sunscreens, anti-corrosion agents, drape imparting agents, anti-static agents, detergents, ironing aids and drying additives. Preferably the fabric conditioner or softener further comprises a compound selected from detergents, ironing aids, and drying additives.

A particularly preferred optional ingredient is an opacifier or pearlescer. Such ingredients can serve to further augment the creamy appearance of the compositions of the invention. Suitable materials may be selected from the Aquasol OP30X range (ex Rohm and Haas), the PuriColour White range (ex Ciba) and the LameSoft™ range (ex Cognis). Such materials are typically used at a level of from 0.01 to 1% by weight of the total composition.

### Aqueous Base

The home care formulations of the invention are typically aqueous. The aqueous base typically comprises 80% or greater by weight of water; sometimes this figure may rise to 90% or greater. The water in the aqueous base generally comprises 40% or greater by weight of the total formulation; preferably this figure is 60% or greater, more preferably it is 70% or greater.

### Fabric Conditioner or Softener Use

The fabric conditioner or softener formulations of the present invention may be used in the rinse cycle of a laundry process, preferably a domestic laundry process. The fabric conditioner formulation is preferably used in the rinse cycle of a domestic fabric laundry process, where, it may be added directly to a washing machine, e.g. through a dispenser drawer or, for a top-loading washing machine, directly into the drum. The compositions may also be used in a domestic hand-washing laundry process.

The fabric conditioner or softener formulation may be in liquid, spray, solid or powder form. The fabric conditioner or softener formulation may be for use as the primary fabric conditioner or softener formulation in the wash cycle or for use as an ancillary formulation in support of a primary formulation.

Method of Treating Fibres and/or Fabrics

Viewed from another aspect, the invention provides a method of treating fibres, comprising the step of applying a composition according any of claims 1 to 8 to the fibres. The fibres may be part of a fabric. The fibres may be part of an item of clothing or garment. The method of treating fibres may occur during a laundry cycle. The method may impart a benefit to the fibres or fabric. The benefit may be selected from fabric conditioning, easy ironing, colour protection, print protection, perfume boosting, odour neutralisation, fabric strength retention and shape retention, fabric softening, faster drying, faster ironing, improved wicking/wetting, reduced static, anti-soil deposition, whiteness protection, stain resistance, reduced irritation, reduced friction, reduced fibre shedding or microplastic release, improved drape, improved haptics, improved well-being.

In this specification, fabric conditioning may refer to conditioning or softening fabric. Easy ironing may refer to the ease with which a fabric or garment can be ironed. Colour protection may refer to protecting or preserving the colour of the fabric or garment during the laundry cycle. Print protection may refer to protecting or preserving a print on the fabric or garment during the laundry cycle. Perfume boosting may refer to improving the performance of a perfume in the formulation used to treat the fibres. Odour neutralisation may refer to neutralisation of malodours trapped in the fibres. Fabric strength retention and shape retention may refer to retaining or preserving the strength or shape of the fabric or garment.

Use of the Composition to Treat Fibres and/or Fabrics

Viewed from another aspect, the invention provides the use of a composition according to the invention to treat fabric to provide a benefit to the fabric, preferably to provide a benefit selected from fabric conditioning, easy ironing, colour protection, print protection, perfume boosting, odour neutralisation, fabric strength retention and shape retention.

The composition of the invention may be used in a pet care formulation. The pet care formulation may be a pet shampoo or conditioning formulation or a pet malodour treatment.

### EXAMPLES

The invention is illustrated by the following non-limiting examples. All parts and percentages are given by weight unless otherwise stated. It will be understood that all tests and physical properties listed have been determined at atmospheric pressure and ambient temperature (i.e. about 23° C.), unless otherwise stated herein, or unless otherwise stated in the referenced test methods and procedures.

### Test Methods

In this specification the following test methods have been used:
(i) Viscosity was measured at room temperature (25° C.) with Brookfield Ametek DV-1 Viscometer using an appropriate spindle (T-C bar). The sample was tested at 10 rpm (0.17 Hz) for 1 minute, immediately and 24 hours after making the sample and results are quoted in cP (mPa·s).
(ii) Formol titre a titration method to determine the degree of substitution of amino groups described by Cobbett, W. G., Gibbs, J. A. and Leach, A. A. (1964). J. Appl. Chem. (London), 14, 296-302
(iii) pH was measured at room temperature (25° C.) with Fisher Scientific Accumet AE150 pH Meter. Depending on the initial pH reading, the pH of the formulation was adjusted to the range of 4.0-5.0 using 10 wt % sodium hydroxide solution (if the pH is lower) or 10 wt % citric acid solution (if the pH is higher). The pH was measured immediately and 24 hours after making the formulation.
(iv) Actives content (in wt %) in the sample was calculated from measuring the total non-volatile content & ash content. Total non-volatile content was measured for a known weight of sample by oven drying at 105° C. for 17-19 hours to remove the moisture and any other volatile components present. After cooling in a desiccator, the residual weight is used to calculate the total non-volatile content (in wt %) of the sample. For ash content, a known weight of sample is heated carefully, using incremental temperature steps, to a temperature of 575-600° C. in the presence of air and held at temperature for 16-18 hours (or longer if necessary). After cooling in a desiccator, the residual weight is used to calculate the ash content (in wt %) of the sample. The actives content (in wt %) in the sample is then calculated by subtracting wt % ash from wt % total non-volatile content.
(v) Weight average molecular weight was determined by Size-Exclusion High-Performance Liquid Chromatography (SE-HPLC). The HPLC apparatus and settings used are given in Table 1.

TABLE 1
HPLC apparatus and settings

| | |
|---|---|
| Spectrometer | Agilent 1200 series HPLC |
| Detector | UV @ 220 nm |
| Columns | Superdex 30 Increase |
| Solvent | 0.1% TFA, 0.1 M Na₂SO₄, 22% MeCN |
| Concentration of | 0.02 g/ml |
| test substance | |
| Column temperature | 25° C. |
| Flow rate | 0.8 ml/min |
| Injection Volume | 10 μL |
| Analysis time | 45 minutes |
| Method control | Agilent OpenLab software |
| and integration | |
| Method Type | Peak area integration |
| Calibration | The following standards (8 points) are used to |
| | calibrate the curve using polynomial 3: 12,384 |
| | (Da) Cytochrome C, 1,423 Bacitracin, 433 |
| | Arg-Gly-Asp-Ser, 146 Glutamine, 3496 Insulin |
| | Chain B, 1355 Vitamin B12, 189 (Gly)3, 75 |
| | Glycine |

(vi) Easy ironing testing was performed using a Tensile Tester (Lloyd LRX) running a pull to limit method (250 mm at 800 mm/min) equipped with an ironing board attachment and a 10N load cell attached to a hot iron in a controlled environment room (relative humidity 50% temperature 22° C.). 100% cotton sheets (50 cm×60 cm) were first prepared for testing by washing at 60° C. in a cotton cycle of a washing machine (Miele W1) with non-biological powder detergent (70 ml) and cotton ballast (2 kg) followed by drying in a tumble dryer (Indesit ID75) for 1 hour at high heat. The cotton sample was then treated by washing at 40° C. in the cotton cycle of the washing machine with non-biological powder detergent (70 ml) and fabric conditioner (25 ml) and cotton ballast (2 kg) and allowed to air dry in the environmentally controlled room for at least 12 hours. The cotton sample was then placed on the ironing board with the hot iron connected to the Tensile Tester on top. The tensile tester then pulled the iron across the sample and recorded the work to limit (Joules). This was repeated three times and an average work to limit recorded. The average percentage change compared to control was then calculated.
(vii) Shape retention testing was performed using a Tensile Tester (Lloyd LRX) running a relaxation method (15 N at 800 mm/min hold for 1 min before relaxing) equipped with a 500N load cell attached to large sample clamps. The garment being tested was treated by washing at 40° C. in a washing machine (Miele W1) with non-biological powder detergent (70 ml) and fabric conditioner (25 ml) and cotton ballast (2 kg) followed by drying in a tumble dryer (Indesit ID75) for 1 hour at high heat. The wash dry cycle was repeated a further 9 times. Samples of the garment were prepared by cutting strips of fabric (16 cm×3 cm) and marking on a test zone (10 cm long, 5 cm either side of centre) before clamping the test piece into the Tensile Tester and stretching the sample following the relaxation method. After the run was complete the test zone was re-measured and the difference in length and width of the test zone calculated. The measurement was repeated on three samples and an average percentage difference from control calculated.
(viii) Colour protection testing was performed using an X-rite colour i5 spectrophotometer running D65 light with UV excluded and 25 mm aperture The garment being tested was treated by washing at 40° C. in a washing machine (Miele W1) with non-biological powder detergent (70 ml) and fabric conditioner (25 ml) and cotton ballast (2 kg) followed by drying in a tumble dryer (Indesit ID75) for 1 hour at high heat. The wash dry cycle was repeated a further 9 times. Colour measurements were taken from several areas of the garment and the average change in colour lightness (DL) compared to the colour of the unwashed garment was determined. The percentage improvement in colour protection from the control was calculated.
(ix) Print protection testing was performed using a panel of untrained people that were asked to rank a series of blind coded printed t-shirts in order of print quality. The garment being tested was treated by washing at 40° C. in a washing machine (Miele W1) with non-biological powder detergent (70 ml) and fabric conditioner (25 ml) and cotton ballast (2 kg) followed by drying in a tumble dryer (Indesit ID75) for 1 hour at high heat. The wash dry cycle was repeated a further 3 times. The panellists scored the prints from 1 to 3 where 1 is for the best quality print and 3 for the worst quality print.

### Example 1

The amino compound which is used to make the composition of the invention may be made by any of Methods A to E below.

### Method A

Potato protein concentrate was added to a hydrochloric acid solution and mixed until well dispersed. The resulting dispersion was heated to reflux conditions. The dispersion was heated until the weight average molecular weight (measured by SE-HPLC as described in the test methods) of the protein stopped reducing, usually in the range of 200-500 Da. Once the hydrolysis was complete the pH of the solution was increase by the addition of sodium hydroxide. The protein hydrolysate was purified by filtration and treatment with activated carbon. Once purified, more sodium hydroxide was added to make the solution basic, and the solution was concentrated to the desired active content (in the range 20 to 30 wt % actives content) by evaporation or ultra-filtration with ultra-filtration having the benefit of salt removal. The resulting product will be referred to as amino compound A

### Method B

Potato protein concentrate was added to a hydrochloric acid solution and mixed until well dispersed. The resulting dispersion was heated to reflux conditions. The dispersion was heated until the weight average molecular weight of the protein stopped reducing, usually in the range of 200-500 Da. The acidic protein hydrolysate was then recovered by filtration. The pH of the solution was then increased by passing the solution through an anion exchange resin to remove the chloride ions. The protein hydrolysate was purified by treatment with activated carbon. Once purified, more sodium hydroxide was added to make the solution basic, and the solution was concentrated to the desired active content (in the range 20 to 30 wt % actives content). The resulting product will be referred to as amino compound B.

### Method C

Potato protein concentrate was added to water and mixed until well dispersed. The resulting dispersion was heated to the desired temperature before the pH was adjusted using sodium hydroxide solution. Enzymes (carbohydrase and protease) were used to catalyse hydrolysis of the potato protein by stirring at the desired temperature and pH ranges to achieve a typical weight average molecular weight of about 400 to 700 Da. Following hydrolysis, the pH of the hydrolysis mixture was lowered to acidic through addition of hydrochloric acid solution and the enzymes were denatured via heating. The protein hydrolysate was purified by filtration and treatment with activated carbon. The resulting dilute hydrolysed protein solution was then adjusted to a basic pH using sodium hydroxide and then concentrated to the desired actives content (in the range 20 to 30 wt % actives content). The resulting product will be referred to as amino compound C.

### Method D

Potato protein concentrate was added to water and mixed until well dispersed. The resulting dispersion was heated to the desired temperature before the pH was adjusted using sodium hydroxide solution. Enzymes (carbohydrase and protease) were used to catalyse hydrolysis of the potato protein by stirring at the desired temperature and pH ranges to achieve a typical weight average molecular weight of about 700 to 950 Da. Following hydrolysis, the pH of the hydrolysis mixture was lowered to acidic through addition of hydrochloric acid solution and the enzymes were denatured via heating. The protein hydrolysate was purified by filtration and treatment with activated carbon. The resulting dilute hydrolysed protein solution was then adjusted to a basic pH using sodium hydroxide and then concentrated to the desired actives content (in the range 20 to 30 wt % actives content). The resulting product will be referred to as amino compound D.

### Method E

Chickpea protein concentrate was added to water and mixed until well dispersed. The resulting dispersion was heated to the desired temperature before the pH was adjusted using sodium hydroxide solution. Enzymes (carbohydrase and protease) were used to catalyse hydrolysis of the chickpea protein by stirring at the desired temperature and pH ranges to achieve a typical weight average molecular weight of about 800 to 1000 Da. Following hydrolysis, the pH of the hydrolysis mixture was lowered to acidic through addition of hydrochloric acid solution and the enzymes were denatured via heating. The protein hydrolysate was purified by filtration and treatment with activated carbon. The resulting dilute hydrolysed protein solution was then adjusted to a basic pH using sodium hydroxide and then concentrated to the desired actives content (in the range 20 to 30 wt % actives content). The resulting product will be referred to as amino compound E.

### Example 2

In a suitable vessel, amino compound D or amino compound E is reacted with itaconic anhydride to produce the composition of the invention according to the following method:
1. Load the amino compound into the vessel.
2. Adjust pH to 9.5-11.0 (preferably 10.0-10.5) with sodium hydroxide. A high pH is preferred to encourage the itaconic anhydride to react with the amino compound instead of with water to avoid or reduce the production of itaconic acid.
3. Add calculated quantity of itaconic anhydride (calculated on the Formol titre, a technique described by Cobbett, W. G., Gibbs, J. A. and Leach, A. A. (1964). J. Appl. Chem. (London), 14, 296-302). In this specific Example, the itaconic anhydride amount added is calculated by Formol titre to react with 25 mol % of the free amino groups of the amino compound over a 15-120 minute period (preferably 30-60 minute period).

This calculation is based on the reaction proceeding to completion, but some itaconic anhydride may react with water to form itaconic acid and prevent the complete reaction of the itaconic anhydride with the amino compound. An example of the calculated quantity of itaconic anhydride required in grams is e.g. 200 (exemplary weight in g of amino compound)×26.55 (exemplary result from Formol titre)×0.02 (molarity of NaOH used in Formol titre)×112 (molecular weight of itaconic anhydride)×0.25 (mol % of free amino groups required to react)/1000 (unit conversion).
4. Maintain temperature at 15-45° C., preferably 20-35° C., and pH at 9.5-11.0, preferably 10.0-10.5, during the itaconic anhydride addition and reaction initiation.
5. Maintain reaction conditions for a further 1-4 hours (preferably 1-2 hours).
6. Acidify to pH 3.5-5.5 (preferably 4.0-5.0) with a mineral acid, such as hydrochloric acid.
7. Preserve by addition of a preservative.
8. Cool and adjust pH to pH 3.5-5.5 (preferably 4.0-5.0).
9. Filter.

The resulting product will be referred to as itaconic modified amino compound D or itaconic modified amino compound E.

### Example 3

The fabric conditioner formulations shown in Table 2 were prepared from the amino compounds of Example 1 and itaconic modified amino compounds of Example 2 as follows.

The Fabric Conditioner used was Sensitive Fabric Conditioner (available from Asda UK) which comprises the following ingredients:
Water
Dihydrogenated tallow hydroxyethylmonium methosulphate
Isopropyl alcohol
Perfume
Polyquaternium-37
2-bromo-2-nitropopane-1,3-diol

TABLE 2
Fabric conditioner formulations

| Formulation | Composition |
|---|---|
| 1 | Fabric Conditioner-Sensitive Fabric |
| (Control) | Conditioner ex Asda |
| 2 | 99 wt % Fabric Conditioner + 1 wt % Amino |
| | Compound D (hydrolysed potato protein) |
| 3 | 99 wt % Fabric Conditioner + 1 wt % Itaconic |
| | Modified Amino Compound D |
| 4 | 99 wt % Fabric Conditioner + 1 wt % Amino |
| | Compound E (hydrolysed chickpea protein) |
| 5 | 99 wt % Fabric Conditioner + 1 wt % Itaconic |
| | Modified Amino Compound E |

### Example 4

Formulations 1 to 5 from Table 2 of Example 3 were tested for easy ironing performance using the easy ironing test method described above. The results are given in Table 3.

TABLE 3

| Easy Ironing test results | |
|---|---|
| | Improvement Compared to |
| Formulation | Control (% change) |
| 1 (control) | 0 |
| 2 | −13%* |
| 3 | +13% |
| 4 | −5%* |
| 5 | +11% |

*negative results show a decrease in performance

Table 3 shows the improved easy ironing performance when itaconic modified amino compound D or E is added to the fabric conditioner compared to the fabric conditioner control without an additive (Formulations 3 & 5). However, a decrease in easy ironing performance is shown when amino compounds D or E are used in the fabric conditioner without itaconic modification (Formulations 2 & 4).

### Example 5

Formulations 1 to 5 from Table 2 of Example 3 were tested for shape retention performance using the shape retention test method described above. The results are given in Table 4.

TABLE 4

| Shape Retention test results | |
|---|---|
| | Improvement Compared to |
| Formulation | Control (% change) |
| 1 (control) | 0 |
| 2 | −5%* |
| 3 | 53% |
| 4 | 12% |
| 5 | 48% |

*negative results show a decrease in performance

Table 4 shows the improved shape retention performance when itaconic modified hydrolysed potato protein (Formulation 3) or itaconic modified hydrolysed chickpea protein (Formulation 5) is added to the fabric conditioner compared to the fabric conditioner control without an additive (Formulation 1) or when just the hydrolysed proteins are used (Formulations 2 & 4).

### Example 6

Formulations 1, 3 & 5 from Table 2 of Example 3 were tested for colour protection performance using the colour protection test method described above. The results are given in Table 5 where a blue cotton t-shirt was the garment being tested and Table 6 where a pair of blue jeans was the garment being tested.

TABLE 5

| Colour Protection test results-cotton t-shirt | |
|---|---|
| | Improvement Compared to |
| Formulation | Control (% change) |
| 1 (control) | 0 |
| 3 | 33% |
| 5 | 33% |

TABLE 6

| Colour Protection test results-blue jeans | |
|---|---|
| | Improvement Compared to |
| Formulation | Control (% change) |
| 1 (control) | 0 |
| 3 | 26% |
| 5 | 47% |

Tables 5 and 6 shows the improved colour protection performance when itaconic modified hydrolysed potato protein (Formulation 3) or itaconic modified hydrolysed chickpea protein (Formulation 5) is added to the fabric conditioner compared to the fabric conditioner control without an additive.

### Example 7

Formulations 1, 3 & 5 from Table 2 of Example 3 were tested for print protection performance using the print protection test method described above. The panellists scored the prints from 1 to 3 where 1 is for the best quality print and 3 for the worst quality print. The results are given in Table 7.

TABLE 7
Print Protection test results

| | Formulation | | |
|---|---|---|---|
| Panellist | 1(control) | 3 | 5 |
| 1 | 3 | 1 | 2 |
| 2 | 3 | 1 | 2 |
| 3 | 3 | 1 | 2 |
| 4 | 3 | 2 | 1 |
| 5 | 3 | 2 | 1 |
| 6 | 3 | 1 | 2 |
| 7 | 3 | 2 | 1 |
| 8 | 3 | 2 | 1 |
| 9 | 3 | 2 | 1 |
| 10 | 3 | 1 | 2 |
| 11 | 3 | 2 | 1 |
| 12 | 3 | 2 | 1 |
| 13 | 3 | 1 | 2 |
| 14 | 3 | 2 | 1 |
| Number of times | 0 | 6 | 8 |
| chosen as the best | | | |
| quality print | | | |

Table 7 shows the score given by the panellists when comparing the quality of prints when itaconic modified hydrolysed potato protein (Formulation 3) or itaconic modified hydrolysed chickpea protein (Formulation 5) is added to the fabric conditioner compared with a control of fabric conditioner alone (Formulation 1). Of the 14 panellists, 6 selected Formulation 3 as giving the best quality print and 8 selected Formulation 5 as giving the best quality print. All panellists selected the print washed with fabric conditioner alone (control) as the poorest quality print.

### Example 8

Formulations of 99 wt % fabric conditioner & 1 wt % of hydrolysed potato or chickpea protein with varying levels of itaconic modification were tested against the fabric conditioner control for shape retention using the shape retention method described above. The results are given in Table 8. The method of Example 2 was followed to make the formulations in Table 8 with Step 3 being modified to use the required amount of itaconic anhydride to provide the desired mol % of itaconic modification.

TABLE 8
Varying Itaconic modification level* Shape Retention results

| | Improvement |
|---|---|
| | compared to |
| Formulation | control (% change) |
| 1 (control) | 0 |
| + 1 wt % Potato 10 mol % Itaconic modified | 3% |
| + 1 wt % Potato 25 mol % Itaconic modified | 53% |
| (Formulation 3-see Table 4) | |
| + 1 wt % Potato 50 mol % Itaconic modified | 27% |
| + 1 wt % Potato 75 mol % Itaconic modified | 7% |
| + 1 wt % Chickpea 10 mol % Itaconic modified | 16% |
| + 1 wt % Chickpea 25 mol % Itaconic modified | 48% |
| (Formulation 5-see Table 4) | |
| + 1 wt % Chickpea 50 mol % Itaconic modified | 23% |

*itaconic modification level calculated using Formol Titre assuming complete reaction

It can be seen from Table 8 that for both hydrolysed potato and chickpea protein, a 25 mol % level of itaconic modification appears to produce better shape retention results.

It is to be understood that the invention is not to be limited to the details of the above embodiments, which are described by way of example only. Many variations are possible.

1. A composition comprising the reaction product of:
a) itaconic anhydride; and
b) an amino compound comprising at least one free amino group, wherein the amino compound is selected from hydrolysed proteins;
wherein the composition comprises itaconic modified amino compound, wherein the itaconic modified amino compound is the reaction product of a) and b).

2. A composition comprising the reaction product of:
a) itaconic anhydride; and
b) an amino compound comprising at least one free amino group, wherein the amino compound is selected from the group consisting of amino acids, peptides and hydrolysed proteins;
wherein the composition comprises itaconic modified amino compound, wherein the itaconic modified amino compound is the reaction product of a) and b), and wherein the amount of itaconic anhydride used in the reaction is calculated to react with 1 mol % to 100 mol % of the free amino groups of the amino compound.

3. A composition according to claim 1 further comprising water.

4. A composition according to claim 1 further comprising itaconic acid.

5. A composition according to claim 1 further comprising a preservative.

6. A composition according to claim 1 wherein the amino compound is a hydrolysed protein.

7. A composition according to claim 1 wherein the amino compound is not a single amino acid.

8. A composition according to claim 1 wherein the amino compound has a weight average molecular weight in the range from 200 Da to 5000 Da.

9. A composition according to claim 1 which does not comprise an organosilane, organosilicon or silicone compound.

10. A composition according to claim 1 which does not comprise a quaternary ammonium compound.

11. A home care formulation comprising a composition according to claim 1.

12. A fabric conditioner or softener comprising a composition according to claim 1.

13. A fabric conditioner or softener according to claim 12 further comprising a fabric softening compound.

14. A fabric conditioner or softener according to claim 12 further comprising a perfume.

15. A fabric conditioner or softener according to claim 12, further comprising a compound selected from detergents, ironing aides, and drying additives.

16. A fabric conditioner or softener according to claim 12, further comprising a quaternary ammonium compound.

17. A fabric conditioner or softener according to claim 12, which does not comprise a quaternary ammonium compound.

18. A method of treating fibres comprising the step of applying a composition according to claim 1 to the fibres.

19. Use of a composition according to claim 1 to treat fibres and/or fabric to provide a benefit to the fibres and/or fabric.
